(19) United States
(12) Patent Application Publication
(10) Pub. No.: US 2014/0316064 A1
(43) Pub. Date: Oct. 23, 2014

(54) Process For Preparing Silicone Emulsions

(71) Applicant: Dow Corning Corporation, MIDLAND, MI (US)

(72) Inventors: Severine Cauvin, Mons (BE); Andreas Stammer, Pont-a-Celles (BE); Andreas Thomas Wolf, Huenstetten (DE)

(21) Appl. No.: 14/357,015

(22) PCT Filed: Nov. 27, 2012
(86) PCT No.: PCT/US2012/066569

§ 371 Date: May 8, 2014

Related U.S. Application Data
(60) Provisional application No. 61/569,500, filed on Dec. 12, 2011.

(51) Int. Cl. C08L 83/04

(52) U.S. Cl. CPC C08L 83/04; C08L 2201/52
USPC 524/745; 524/837

(57) ABSTRACT

The present disclosure provides a process for preparing silicone emulsions via suspension polymerization techniques that are faster and/or provide higher molecular weight organopolysiloxanes than conventional techniques. The process involves combining a) an emulsifier, b) a silanol functional organopolysiloxane, c) a polymerization catalyst, and water to form a mixture, shearing the mixture to form an emulsion having a dispersed phase of the organopolysiloxane, reacting the emulsion in a closed system having a pressure greater than 1 MPa to polymerize the organopolysiloxane.

### CROSS-REFERENCE TO RELATED APPLICATIONS

This application claims the benefit of U.S. Patent Application No. 61/569,500, as filed on 12 Dec. 2011.

### BACKGROUND OF THE INVENTION

Silicone emulsions are well known in the art. Silicone emulsions can be made by processes such as (i) mechanical emulsification, (ii) mechanical emulsification by inversion, or by (iii) emulsion polymerization. However, because of the high viscosity of some silicones such as high molecular weight silicone fluids, silicone gums, silicone rubbers, silicone elastomers, and silicone resins, their emulsification are often limited to using emulsion polymerization techniques. Attempts to use mechanical methods for emulsifying silicone gums, silicone rubbers, silicone elastomers, and silicone resins, have also been limited because of the difficulty to incorporate a surfactant or a mixture of surfactants into the silicone gum, silicone rubber, silicone elastomer, or silicone resin. It is also difficult to incorporate water into mixtures containing high viscosity silicones, a surfactant, or a mixture of surfactants, and at the same time impart sufficient shear to cause inversion. Yet another approach for preparing emulsions of high viscosity silicones involves techniques know as suspension polymerization, where low molecular weight siloxanes are first emulsified and then polymerized within the dispersed particles of the emulsion. For example polycondensation of oligomeric OH-siloxane to high molecular weight polymers, dispersed in an aqueous phase, are used in the silicone industry. However in order to obtain high molecular weight polymers using suspension polymerization techniques, extended reaction times are often required. Thus, there is a need to improve the reaction times needed to prepare silicone emulsions using suspension polymerization techniques.

Reducing the presence of solvents, un-reacted siloxanes, catalyst residues, cyclic polymerization byproducts, and other impurities in silicone emulsions is another ongoing challenge in the art. The need to reduce such impurities may arise, among other reasons, when such impurities are incompatible with downstream applications (for example, medical, cosmetic, and personal care applications), where the presence of such impurities would reduce the stability of an emulsion, or where regulatory requirements require removal or reduction of their presence. In particular, there is an interest to reduce the presence of cyclosiloxanes, such as octamethylcyclotetrasiloxanes (D4) and decamethylcyclopentasiloxanes (D5), in silicone emulsions.

### BRIEF SUMMARY OF THE INVENTION

The present inventors have discovered a process for preparing silicone emulsions via suspension polymerization techniques that are faster and/or provide higher molecular weight organopolysiloxanes than conventional techniques. The present process also provides silicone emulsions having a reduced concentration of cyclosiloxanes.

The present disclosure provides a process for producing a silicone emulsion comprising the steps of:
I) combining;
   a) an emulsifier,
   b) a silanol functional organopolysiloxane,
   c) a polymerization catalyst ,
      and water to form a mixture,
II) shearing the mixture to form an emulsion having a dispersed phase of the organopolysiloxane ,
III) reacting the emulsion of step II) in a closed system having a pressure greater than
   1 MPa to polymerize the organopolysiloxane.

### DETAILED DESCRIPTION OF THE INVENTION

Features and advantages of the invention will now be described with occasional reference to specific embodiments. However, the invention may be embodied in different forms and should not be construed as limited to the embodiments set forth herein. Rather, these embodiments are provided so that this disclosure will be thorough and complete and will fully convey the scope of the invention to those skilled in the art.

The first step in the present process for producing a silicone emulsion involves:
I) combining;
   a) an emulsifier,
   b) a silanol functional organopolysiloxane, and
   c) a polymerization catalyst.

Component a) is an emulsifier. As used herein, “emulsifier” refers to any compound or substance that enables the formation of an emulsion. The emulsifier may be selected from any surface active compound or polymer capable of stabilizing emulsions. Typically, such surface active compounds or polymers stabilize emulsions by preventing coalescence of the dispersed particles. The surface active compounds useful as emulsifiers in the present process may be a surfactant or combination of surfactants. In principle, the surfactant used can be any surfactant known for emulsification of silicones and can be cationic, anionic, nonionic, and/or amphoteric. Mixtures of surfactants of different types and/or different surfactants of the same type can be used. Where more than one surfactant is used, the surfactants can be premixed, added simultaneously, or can be added successively to form the mixture in step I).

Some suitable anionic surfactants which can be used include (i) sulfonic acids and their salts, including alkyl, alkylaryl, alkylnapthalene, and alkyldiphenylether sulfonic acids, and their salts, having at least 6 carbon atoms in the alkyl substituent, such as dodecylbenzensulfonic acid, and its sodium salt or its amine salt; (ii) alkyl sulfates having at least 6 carbon atoms in the alkyl substituent, such as sodium lauryl sulfate; (iii) the sulfate esters of polyoxyethylene monoalkyl ethers; (iv) long chain carboxylic acid surfactants and their salts, such as lauric acid, steric acid, oleic acid, and their alkali metal and amine salts.

It should be noted that certain anionic surfactants such as dodecylbenzene sulfonic acid, are capable of functioning both as a surfactant and a catalyst; in which case, the need for an additional acid catalyst, may or may not be needed. The use of a combination of an anionic surfactant and a strong acid catalyst such as sulfuric acid is also a viable option. Anionic surfactants that are commercially available include dodecylbenzenesulfonic acid sold under the names Bio-Soft S-100 or Bio-Soft S-101, and its triethanolamine salt sold under the name Bio-Soft N-300 by the Stepan Company, Northfield, Ill.

Some suitable cationic surfactants which can be used include (i) fatty acid amines and amides and their salts and derivatives, such as aliphatic fatty amines and their derivatives; and (ii) quaternary ammonium compounds such as alkyl trimethylammonium and dialkyldimethylammonium halides, or acetates, or hydroxides, having at least 8 carbon atoms in each alkyl substituent. Cationic surfactants that are commercially available include compositions sold under the names Arquad T27 W, Arquad 16-29, by Akzo Nobel Chemicals Inc., Chicago, Ill.; and Ammonyx Cetac-30 by the Stepan Company, Northfield, Ill.

The amount of anionic surfactant and cationic surfactant can be 0-50 percent by weight based on the weight of the polysiloxane to be formed. The exact amount will necessarily depend on the particular particle size of the polysiloxane in the emulsion being targeted. Typically, less than 20 percent by weight, based on the weight of the polysiloxane to be formed, of the active anionic surfactant or the cationic surfactant, can be used to produce emulsions containing polysiloxane particles.

The nonionic surfactants for use according to the present process may have a hydrophilic-lipophilic balance (HLB) between 10-20. While nonionic surfactants with an

HLB of less than 10 can be used, a hazy solution is likely to result, due to the limited solubility of the nonionic surfactant in water, with the result that an effective surfactant effect does not occur. It is preferred therefore, that when using a nonionic surfactant with an HLB of less than 10, that another nonionic surfactant with an HLB of greater than 10 be added, so that the combined HLB of the two surfactants is greater than 10.

Some suitable nonionic surfactants which can be used include polyoxyethylene alkyl ethers, polyoxyethylene alkyl phenyl ethers, polyoxyethylene fatty acid esters, sorbitan fatty acid esters, and polyoxyethylene sorbitan fatty acid esters. Nonionic surfactants which are commercially available include compositions such as (i) 2,6,8-trimethyl-4-nonyl polyoxyethylene ether sold under the names Tergitol TMN-6 and Tergitol TMN-10; (ii) the C11-15 secondary alkyl polyoxyethylene ethers sold under the names Tergitol 15-S-7, Tergitol 15-S-9, Tergitol 15-S-15, Tergitol 15-S-30, and Tergitol 15-S-40, by the Dow Chemical Company, Midland, Mich.; octylphenyl polyoxyethylene (40) ether sold under the name Triton X405 by the Dow Chemical Company, Midland, Mich.; (iii) nonylphenyl polyoxyethylene (10) ether sold under the name Makon 10 by the Stepan Company, Northfield, Ill.; (iv) ethoxylated alcohols sold under the name Trycol 5953 by Henkel Corp./Emery Group, Cincinnati, Ohio; and (v) ethoxylated alcohols sold under the name Brij L23 by Croda Inc. Edison, N.J.

The nonionic surfactant may also be a silicone polyether (SPE). The silicone polyether may have a rake type structure wherein the polyoxyethylene or polyoxyethylene-polyoxypropylene copolymeric units are grafted onto the siloxane backbone, or the SPE can have an ABA block copolymeric structure wherein A represents the polyether portion and B the siloxane portion of an ABA structure.

Component b) is a silanol functional organopolysiloxane. Organopolysiloxanes are polymers containing siloxy units independently selected from (R₃SiO_{1/2}), (R₂SiO_{2/2}), (RSiO_{3/2}), or (SiO_{4/2}) siloxy units, where R may be any organic group. These siloxy units are commonly referred to as M, D, T, and Q units respectively. These siloxy units can be combined in various manners to form cyclic, linear, or branched structures. The chemical and physical properties of the resulting polymeric structures vary depending on the number and type of siloxy units in the organopolysiloxane. The organopolysiloxanes useful as component b) in the present process may be any organopolysiloxane, providing it contains at least two silanol groups in its molecule. The organopolysiloxane useful as component b) may also be in a combination with organopolysiloxanes having less than two silanol groups in order to control the final molecular weight or produce non-silanol terminal polymers.

The organopolysiloxane selected for component b) may also be a combination or mixture of several organopolysiloxanes, differing in at least one manner such as structure or viscosity.

In one embodiment, the silanol-functional organopolysiloxane is a substantially linear polydiorganosiloxane fluid such as polydimethylsiloxane, although branched polysiloxanes can also be used. The silanol groups are preferably terminal groups on the organopolysiloxane chain. The organopolysiloxane fluid can for example have a viscosity of at least 0.01 Pa·s up to 1000 Pa·s at 23° C., or alternatively at least 0.02 Pa·s up to 100 Pa·s at 23° C., or alt alternatively at least 0.05 Pa·s up to 0.5 Pa·s at 23° C.

Component c) is a polymerization catalyst which can affect polymerization of the organopolysiloxane. In preferred embodiments, the polymerization catalyst is a condensation catalyst. In principle, any suitable condensation catalyst known in the art may be utilized in the process. In certain aspects, protic acids, Lewis acids and bases, organic acids and bases, and inorganic acids and bases are used. For example, BF₃, FeCl₃, AlCl₃, ZnCl₂, and ZnBr₂ can be used. Alternatively, organic acids such as those having the general formula RSO₃H, wherein R represents an alkyl group having from 6 to 18 carbon atoms (for example, a hexyl or dodecyl group), an aryl group (for example, a phenyl group), or an alkaryl group (for example, dodecylbenzyl) can be used. In certain aspects, dodecylbenzenesulphonic acid (DBSA) is the catalyst used. Other condensation-specific catalysts suitable for the reactive extrusion process include, but are not limited to, n-hexylamine, tetramethylguanidine, carboxylates of rubidium or cesium, hydroxides of potassium, sodium, magnesium, calcium or strontium, and phosphonitrile halide ion-based catalysts having the general formula [X(PX₂═N)_{z}PX₃]⁺, wherein X denotes a halogen atom and wherein z is an integer from 1 to 6. In certain aspects, [PCl₃═N—PCl₂═N—PCl₃]⁺PCl₆ is the catalyst used.

Other optional components may be added in step I), provided they do not inhibit or deter the subsequent polymerization reaction that occurs in step III of the process. Such optional components include foam control agents, anti-freeze agents, and biocides. Alternatively, such components may be added upon formation of the silicone emulsion.

The amounts of components a), b), c), any additional optional components, and water used to prepare the mixture in step I) may vary. Typically, the weight percent amounts of each in the mixture of step I) may ranges as follows:
a) the emulsifier from 0 to 40 wt %, alternatively from 0.1 to 25 wt % alternatively from 0.5 to 10 wt %;
b) the silanol functional organopolysiloxane from 1 to 80 wt %, alternatively from 5 to 50 wt %, alternatively from 10 to 40 wt %;
c) the polymerization catalyst from 0.001 to 20 wt %, alternatively from 0.01 to 10 wt %, alternatively from 0.01 to 5 wt %;
   where the amounts of a), b), c), any optional components, and water sums to 100 wt %.

Step II in the present process involves shearing the mixture formed in step I) to form an emulsion having a dispersed phase of the organopolysiloxane. Thus, components a), b), c) and water are combined and mixed with sufficient shear force to form an aqueous continuous emulsion having the silanol functional organopolysiloxane as part of the dispersed oil phase. The mixing may occur either as a batch, semi-continuous, or continuous process. The mixing may be effected by shear mixing techniques such as provided by a homogenizer, sonolator. Mixing may occur, for example using, batch mixing equipments with medium/low shear include change-can mixers, double-planetary mixers, conical-screw mixers, ribbon blenders, double-arm or sigma-blade mixers; batch equipments with high-shear and high-speed dispersers include those made by Charles Ross & Sons (NY), Hockmeyer Equipment Corp. (NJ); batch equipments with high shear actions include Banbury-type (CW Brabender Instruments Inc., NJ) and Henschel type (Henschel mixers America, TX). Illustrative examples of continuous mixers/compounders include extruders single-screw, twin-screw, and multi-screw extruders, corotating extruders, such as those manufactured by Krupp Werner & Pfleiderer Corp (Ramsey, N.J.), and Leistritz (NJ); twin-screw counter-rotating extruders, two-stage extruders, twin-rotor continuous mixers, dynamic or static mixers or combinations of these equipments.

Step III in the present process involves reacting the emulsion of step II) in a closed system having a pressure greater than 1 MPa to polymerize the organopolysiloxane. As used herein “polymerize” means effecting a condensation polymerization reaction of the organopolysiloxane in the emulsion resulting from step II).

The inventors found that polymerizing the organosiloxane in the emulsion from step II) in a closed system having a pressure greater than 1 MPa (1,000,000 Pascals), alternatively greater than 10 MPa (1,000,000 Pascals), alternatively greater than 20 MPa, alternatively greater than 30 MPa, alternatively greater than 40 MPa, resulted in a significantly higher molecular weight of the polymerized organopolysiloxane than otherwise would be produced under the atmospheric pressure. In the view of the inventors, this is completely unexpected because the reaction takes places solely in the liquid phase and as such the effect of pressure on such a process would have been expected to be negligible because both the reactants and the products are liquids and the change in volume is not so significant as to lead to an expectation of a significant decrease in volume of the products compared to the reactants.

The polymerization reaction in step III of the emulsion made in step II may proceed in any equipment suitable for providing mixing of the components at pressures above 1 MPa. The mixing may occur either as a batch, semi-continuous, or continuous process. Mixing may occur, for example using, batch mixing equipment with medium/low shear capability. Included as laboratory sized examples, but not limited to, are a (i) Parr® Bench Top Reactor as supplied by Parr Instrument Company of Moline, Ill.; or an (ii) LC series Bench Stand Model as supplied by Pressure Products Industries, Milton Roy of Warminster, Pa.; or a (iii) BR series High Pressure Reaction Vessel as supplied by Berghof of Eningen, Germany; or (iv) several models available from Autoclave Engineers of Erie, Pa. Many of these suppliers also offer custom solutions for designing and building a production scale version of their lab scale models. Other custom solution suppliers for large scale production would be (i) Zeyon of Erie, Pa; (ii) Pressure Chemical Company of Pittsburgh, Pa.; (iii) Pfaudler of Rochester, N.Y.; and (iv) High Pressure Autoclave Reactors from Ernst Haage of Germany.

The polymerization reaction of step II) typically proceeds while simultaneously mixing and controlling the temperature of the emulsion composition resulting from step II). Such polymerization processes of the present invention are typically carried out at a temperature in the range of 0-100 ° C., or alternatively in the range of 5-95 ° C. or alternatively in the range of 10-50 ° C. Temperature below 0° C. can be used under special pressure conditions as soon as the emulsion stays in its liquid state.

The polymerization reaction effected in step III) can be stopped at the desired level of polymerization of the organopolysiloxane. Reaction times of less than 24 hours, and typically less than 5 hours, are sufficient to achieve the desired particle size and/or level of conversion. The methods for stopping the reaction typically encompass neutralization of the catalyst by the addition of equal or slightly greater stoichiometric amount of acid or base (depending upon the type of catalyst). Either a strong or weak acid/base may be used to neutralize the reaction. Care must be taken when using a strong acid/base not to over neutralize as it may be possible to re-catalyze the reaction. It is typical to neutralize with sufficient quantities of acid or base such that the resulting emulsion has a pH of less than 7 when a cationic surfactant is present and a pH of greater than 7 when an anionic surfactant is present.

The molecular weight of the organopolysiloxane may be readily determined by techniques known in the art. Typically, the silicone phase is recovered from the emulsion, and the molecular weight of the organopolysiloxane determined using GPC (Gel

Permeation Chromatography).

Using the present methods, organopolysiloxane having molecular weights (M_{W}) greater than 200 kg/mol are readily possible.

The present emulsions may be characterized by average volume particle of the dispersed silicone phase in a continuous aqueous phase. The particle size may be determined by laser diffraction of the emulsion. Suitable laser diffraction techniques are well known in the art. The particle size is obtained from a particle size distribution (PSD). The PSD can be determined on a volume, surface, length basis. The volume particle size is equal to the diameter of the sphere that has the same volume as a given particle. The term Dv represents the average volume particle size of the dispersed particles. Dv 50 is the particle size measured in volume corresponding to 50% of the cumulative particle population. In other words if Dv 50 =10 μm, 50% of the particle have an average volume particle size below 10 μm and 50% of the particle have a volume average particle size above 10 μm. Dv 90 is the particle size measured in volume corresponding to 90% of the cumulative particle population.

The average volume particle size of the dispersed siloxane particles in the oil/water emulsions is between 100 nm and 1000 nm; or between 100 nm and 500 nm; or between 100 nm and 300 nm.

In certain embodiments, the present silicone emulsions may also be characterized as having less than 0.6 weight% of D4 and D5 cyclic siloxanes. The D4 and D5 content may be determined by known gas chromatography (GC) techniques.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention. All percentages are in wt. %. All measurements were conducted at 23° C. unless indicated otherwise.

A polydimethylsiloxane polymer was prepared by emulsifying 363.7 g of a hydroxyl terminated polydimethylsiloxane having a viscosity of 70 mPa·s at 25° C. in 264.2 g water using the neutralisation product of 19.7 g of DBSA and 16.7 g TEA as surfactant.

The following procedure was used for the emulsification:
Mix DBSA and water
Add TEA under stirring
Addition of the siloxane under stirring (Ika mixer 1 hour)
Pass the emulsion 3 times through a Rannie at 700 bar (APV system 200, homogeneizer of SPX brand)
   The emulsion was split into a reference (d: not catalysed) and a second part which was activated with 0.1369 parts sulphuric acid (with a concentration of 10%by weight) per 100 parts by weight of the emulsion. The activated part was kept for 5 hours under various conditions:
a) 1 bar pressure agitated on a shaking table (90/min velocity)
b) 250 bar (25MPa) pressure on a shaking table (90/min velocity)
c) 1 bar pressure not agitated
   The pressure was released (in case of example b) and the polymerisation was stopped, by the addition of 0.0593 parts of TEA (triethanolamine >99%) per 100 parts by weight of the emulsion for examples a-c.
   The so obtained polymers were analyzed by GPC for their molecular weight and GC for their content of volatile cyclics siloxane.

| | Mn | Mw | | | |
|---|---|---|---|---|---|
| | kg/mol | kg/mol | PD | % D₄ | % D₅ |
| a: 1 bar (agitated) | 136 | 190 | 1.40 | 0.31 | 0.13 |
| b: 250 bar (agitated) | 163 | 227 | 1.39 | 0.36 | 0.14 |
| c: 1 bar | 135 | 194 | 1.43 | 0.28 | 0.12 |
| d: 1 bar not catalyzed | 3.5 | 6.4 | 1.85 | 0.10 | 0.10 |

The results show that at 250 bar higher molecular weight polymer was obtained compared to atmospheric pressure.
Particle size of the emulsion and viscosity of the oil phase were measured for all samples and are indicated in the following table.

| | d(0.1) nm | d(0.5) nm | d (0.9) nm | Visc. (Pas0 |
|---|---|---|---|---|
| a: 1 bar (agitated) | 121 | 213 | 417 | 415 |
| b: 250 bar (agitated) | 119 | 224 | 395 | 894 |
| c: 1 bar | 134 | 224 | 434 | 433 |
| d: 1 bar not catalysed | 118 | 203 | 370 | — |

1. A process for producing a silicone emulsion comprising the steps of:
I) combining;
a) an emulsifier,
b) a silanol functional organopolysiloxane,
c) a polymerization catalyst,
and water to form a mixture,
II) shearing the mixture to form an emulsion having a dispersed phase of the organopolysiloxane,
III) reacting the emulsion of step II) in a closed system having a pressure greater than 1 MPa to polymerize the organopolysiloxane.

2. The process of claim 1 where the emulsifier is an anionic surfactant.

3. The process of claim 1 where the emulsifier is dodecylbenzensulfonic acid, an amine salt of dodecylbenzensulfonic acid, or a combination thereof.

4. The process of claim 1 where the silanol functional organopolysiloxane is a silanol terminated polydimethylsiloxane having a viscosity of at least 0.02 Pa·s at 23° C.

5. The process of claim 1 where the polymerization catalyst is dodecylbenzensulfonic acid.

6. The process of claim 1 wherein the weight percent amounts of each component in the mixture of step I) is:
a) the emulsifier from 0 to 40 wt %,
b) the silanol functional organopolysiloxane from 1 to 80 wt %,
c) the polymerization catalyst from 0.01 to 20 wt %,
where the amounts of a), b), c), and water sums to 100 wt %.

7. The process of claim 1 where step III) proceeds in a closed system having a pressure greater than 10 MPa.

8. A silicone emulsion prepared according to claim 1.

9. The silicone emulsion of claim 8 where the organopolysiloxane has a molecular weight (M_{W}) greater than 200 kg/mol.

10. The silicone emulsion of claim 9 wherein the emulsion has less than 0.6 weight of D4 and D5 cyclic siloxanes.

11. The process of claim 2 where the silanol functional organopolysiloxane is a silanol terminated polydimethylsiloxane having a viscosity of at least 0.02 Pa·s at 23° C.

12. The process of claim 3 where the silanol functional organopolysiloxane is a silanol terminated polydimethylsiloxane having a viscosity of at least 0.02 Pa·s at 23° C.

13. The process of claim 2 where the polymerization catalyst is dodecylbenzensulfonic acid.

14. The process of claim 3 where the polymerization catalyst is dodecylbenzensulfonic acid.

15. The process of claim 4 where the polymerization catalyst is dodecylbenzensulfonic acid.

16. The process of claim 3 wherein the weight percent amounts of each component in the mixture of step I) is:
a) the emulsifier from 0 to 40 wt %,
b) the silanol functional organopolysiloxane from 1 to 80 wt %,
c) the polymerization catalyst from 0.01 to 20 wt %,
where the amounts of a), b), c), and water sums to 100 wt %.

17. The process of claim 4 wherein the weight percent amounts of each component in the mixture of step I) is:
a) the emulsifier from 0 to 40 wt %,
b) the silanol functional organopolysiloxane from 1 to 80 wt %,
c) the polymerization catalyst from 0.01 to 20 wt %,
where the amounts of a), b), c), and water sums to 100 wt %.

18. The process of claim 5 wherein the weight percent amounts of each component in the mixture of step I) is:
a) the emulsifier from 0 to 40 wt %,
b) the silanol functional organopolysiloxane from 1 to 80 wt %,
c) the polymerization catalyst from 0.01 to 20 wt %,
where the amounts of a), b), c), and water sums to 100 wt %.

19. The process of claim 6 where step III) proceeds in a closed system having a pressure greater than 10 MPa.

20. A silicone emulsion prepared according to claim 19.
